(19) United States
(12) Patent Application Publication
(10) Pub. No.: US 2012/0095829 A1
(43) Pub. Date: Apr. 19, 2012

(54) Systems and Methods for Managing Contracts and Contract Bids

(76) Inventors: Joseph Bradley Harper, Lexington, SC (US); Robert Smith Jones, Columbia, SC (US)

(21) Appl. No.: 13/274,241

(22) Filed: Oct. 14, 2011

Related U.S. Application Data
(60) Provisional application No. 61/393,848, filed on Oct. 15, 2010.

(51) Int. Cl. G06Q 30/08; G06Q 30/02

(52) U.S. Cl. 705/14.49; 705/26.3

(57) ABSTRACT

Systems and methods for managing contracts and contract bids is provided. Systems may include a memory for storing executable instructions for managing contract bids; and a processing system configured to execute the instructions stored in the memory. Executing the instructions causes the processing system to receive project parameters from at least one builder; receive bids from a plurality of contractors, each bid including a quote corresponding to a project parameter; map each quote in the received bids to the corresponding project parameter; identify discrepancies between the mapped quotes, and adjust at least one quote based on the discrepancies. The project parameters may include a building plan, a scope of work, and a materials specification. The processing system may display an advertisement to the builder when the builder is entering or reviewing the project parameters, the advertisement may include content that substantially relates to the project parameters.

### CROSS-REFERENCE TO RELATED APPLICATIONS

The present application claims priority to co-pending U.S. Provisional Application No. 61/393,848, filed Oct. 15, 2010, entitled “Managing Contracts and Contract Bids”, which is hereby incorporated by reference herein in its entirety.

### FIELD OF THE INVENTION

The present disclosure generally relates to contract and bid management, and more particularly, to systems and methods for managing contracts and contract bids.

### BACKGROUND

Builders and/or developers generally work with many contractors in the course of a building project or multiple building projects. Contractors, Suppliers, Manufacturers, and Products are generally chosen through a bidding process in which the builders provide general bidding guidelines and the contractors provide a proposed bid. The bidding guidelines generally depend on the parameters of the project, which may change in some cases. As such, the proposed bid may have to be modified in order to reflect applicability to the new parameters. In addition, different contractors may present certain information differently such that the bids the builders receive may not appear to be consistent between different contractors. In such circumstances, it becomes difficult to evaluate contractor bids. There is, therefore, a need for systems and methods for managing contracts and contract bids which eliminates these and other problems with existing systems.

### SUMMARY OF THE INVENTION

According to various embodiments, a system is provided for managing contracts and contract bids, the system including a memory for storing executable instructions for managing contract bids; and a processing system configured to execute the instructions stored in the memory. Executing the instructions causes the processing system to receive project parameters from at least one builder; receive bids from a plurality of contractors, each bid including a quote corresponding to a project parameter; map each quote in the received bids to the corresponding project parameter; identify discrepancies between the mapped quotes, and adjust at least one quote based on the discrepancies. The project parameters may include a building plan, a scope of work, and a materials specification. Executing the instructions may further cause the processing system to display an advertisement to the builder when the builder is entering or reviewing the project parameters. The advertisement may include content that substantially relates to the project parameters. In some embodiments, the advertisement may be provided by a manufacturer, supplier, or contractor to the builder. In some embodiments, the advertisement may also be readily converted into a contract between the two parties based on the builder or trades pre-set parameters from their bid. Executing the instructions may further cause the processing system to request an updated bid from a preferred contractor based on the adjusted quotes. Executing the instructions may also cause the processing system to maintain a historical database comprising a plurality of contracts having project parameters and the corresponding bids received from contractors for each of the contracts. At least one quote may be adjusted based on a comparison with substantially similar quotes received in bids maintained in the historical database. Executing the instructions may even further cause the processing system to permit a builder to access at least a portion of the historical database when entering the project parameters. Executing the instructions may further cause the processing system to provide the received bids having the adjusted quotes to the builder and permit the builder to select a bid. The builder selecting the bid may form a contract between the builder and the contractor providing the selected bid. The memory may further store a plurality of form contracts and further wherein the system provides the contract to the contracting builder and contractor. Executing the instructions may still further cause the processing system to receive one or more payment requests from the selected contractor during performance of the contract and to provide said payment requests to the builder, wherein the builder can approve or deny the payment requests. In some embodiments, approval of the payment request by the builder may be provided to a financial institution to confirm that the builder has actually made payment to the contractor.

According to some embodiments, a system is provided that may include a communication system configured to operate on a communications medium and to receive bids from a plurality of contractors, each bid including a quote corresponding to a project parameter; a memory for storing the bids and the project parameters; and a processing system configured to map each quote in the bids to the corresponding project parameter and to compare the project parameters included in the quotes so as to identify discrepancies between the quotes, the processing system being further configured to adjust the quotes such that the project parameters are substantially similar between the received bids. The communications medium may be the internet. The processing system may be further configured to receive the bids from the plurality of contractors via one or more web pages. The processing system may be further configured to permit at least one builder to enter the project parameters. The processing system may be still further configured to display an advertisement to the builder when the builder is entering or reviewing the project parameters. The advertisement may include content that substantially relates to the project parameters being entered. The processing system may be a web server operating on the internet.

According to even further embodiments, a method is provided for managing contract bids, the method including receiving bids from a plurality of contractors, each bid including a quote corresponding to a project parameter; mapping, by a processing system, each quote in the received bids to the corresponding project parameter; identifying, by the processing system, a discrepancy between a project parameter submitted by a first contractor and a project parameter submitted by a second contractor; and adjusting at least one quote associated with the first contractor based on matching the project parameter submitted by the first contractor to the project parameter submitted by the second contractor. The method may further include displaying an advertisement to a builder entering or reviewing the project parameters, wherein the advertisement includes content that substantially relates to the project parameters being entered. The bids may be received from the plurality of contractors via the internet. The method may further comprise requesting an updated bid from at least one of the contractors based on the adjusted quotes. The method may further comprise maintaining a historical database comprising a plurality of previously awarded contracts having project parameters and the corresponding bids received from contractors for each of the contracts.

### BRIEF DESCRIPTION OF THE DRAWINGS

FIG. 1 is a block diagram of an exemplary architecture of a system for practicing aspects of the present technology;

FIG. 2 is a block diagram of an exemplary system for practicing various embodiments;

FIG. 3 is a flow diagram illustrating a method for managing contracts and contract bids;

FIG. 4 is a screen shot illustrating an exemplary Trade Contract Master page;

FIG. 5 is a screen shot illustrating an exemplary Plan Setup page;

FIG. 6 is a screen shot illustrating an exemplary Plan Setup/Dashboard page;

FIG. 7 is a screen shot illustrating an exemplary Active Project Bids page;

FIG. 8 is a screen shot illustrating an exemplary Bid Management page;

FIG. 9 is a screen shot illustrating an exemplary Review Bids page;

FIG. 10 is a screen shot illustrating an exemplary Release Work Orders page;

FIG. 11 is a screen shot illustrating an exemplary Builder Insurance Agent Setup page;

FIG. 12 is a screen shot illustrating an exemplary Bid page;

FIG. 13 are screen shots illustrating an exemplary apples-to-apples function;

FIG. 14 is a screen shot illustrating an exemplary Take-Off Tracker page;

FIG. 15 is a screen shot illustrating an exemplary Product Description Standardization page; and

FIG. 16 are screen shots illustrating an exemplary Low Price Generator function.

### DETAILED DESCRIPTION OF THE INVENTION

Before explaining the presently disclosed and claimed inventive concept(s) in detail by way of exemplary embodiments, drawings, and appended claims, it is to be understood that the present disclosure is not limited in its application to the details of construction and the arrangement of the components set forth in the following description or illustrated in the drawings. The present disclosure is capable of other embodiments or of being practiced or carried out in various ways. As such, the language used herein is intended to be given the broadest possible scope and meaning; and the embodiments are meant to be exemplary—not exhaustive. It is to be understood that the phraseology and terminology employed herein is for the purpose of description and should not be regarded as limiting. Unless otherwise required by context, singular terms may include pluralities and plural terms may include the singular.

It is to be understood that the term “trade”, “trade contractor” or “contractor” as used herein generally refers to a labor provider, a services provider, a materials provider, a supplier, a distributor, a turn-key tradesman, a vendor or anything of the like generally and normally involved in the construction process or associated trades

Generally, the systems and methods provided herein may provide a mechanism for managing contracts and contract bids. The presently disclosed systems and methods may be useable by a builder or a developer as well as by contractors, material suppliers, financial institutions, insurance agents, governmental regulatory agencies, etc. Generally, various embodiments may provide for systems and methods that permit, at applicable times in the building project, said entities to enter and exchange information (e.g., bids) relating to the building project, enter into contracts between selected entities relating to various aspects of the building project, track and monitor the progress of the building progress, control payment authorizations, etc.

Typically, builders are responsible for creating a budget and cost analysis associated with a building project, e.g., building a house, a facility, etc. To accomplish the foregoing, builders generally use an estimating process involving determination of what materials are required and the amount of materials required. Embodiments of the present invention transfer at least part of the tasks to the contractor(s), who are not only getting paid for the work but also have the expertise and specific skills that will allow them to provide more accurate numbers. One of the risks, however, in allowing such contractors to prepare the quantitative calculations is the possibility of manipulating quantities or otherwise hiding profit in the bids. Embodiments of the present invention may use the past and current performance/bids from trade contractors for building projects similar in scope and/or materials to keep the trade contractors honest. Certain aspects may provide for two bids in the same format to ease intelligent analysis of the bids, while each additional bid accumulates and draws closer to “Perfect Information.” Various embodiments may leverage the 80/20 Rule and the Iterations Theory of Learning to transform raw data into useful knowledge. Managing contracts and contracts bids according to embodiments of the present invention can prevent such manipulation and deceptive practices by contractors. Generally, doing these things the “right way” as mentioned above is complicated and time-consuming without tools such as those described herein or a customized enterprise resource planning (ERP) system and employees to run it.

It is also generally understood that it is necessary to make certain unavoidable changes on the jobsite during the course of a building project. One of the major risks associated with what changes is the importance in getting up front pricing on the change. This pricing may be competitive or may be specific to the trade under contract. Two important aspects of this are documenting the price upfront, and tracking that price so that the agreed-to price is the amount paid at the time of payment. As such, certain embodiments may employ tools that allow quoting and pricing via email, cell phones, and computers that may be rolled directly into existing contracts and budgets and tracked for reporting, expense, and profit calculations.

It is also generally understood that there are strategic formulas that can be used in the estimating process based on certain house plan parameters. In some instances, various embodiments may also verify bid and price quotes against these formulas to help determine if estimates are accurate and consistent. For example, historical contracts and other information regarding bids over time may be stored in a historical database and accessed to improve on the effectiveness of these formulas over time through the wisdom and experience of iterations and knowledge of crowds. Also, over time trade specific formulas and bidding techniques may be incorporated by trade code or task code to provide more powerful and effective pricing quotes.

On average, builders build 2-3 houses per year over a 15 year career. As such, many builders will have been involved in building 30 to 45 houses in a course of their career. The knowledge base and intelligent analytical tools of the present disclosure may allow such builders and/or contractors to benefit from the knowledge and wisdom of others by farming the historical database for similar building projects and their associated bids and project parameters. Such knowledge may include, for example, planned costs vs. actual costs, what failures occur, and what led to such failures in the construction of thousands of houses. Embodiments of the present invention may leverage the Process of Failing Forward™ to capture the negative energy that accompanies a failure and transforms it into a positive learning experience that can be reutilized to support future growth and to minimize such failures. As such, builders and/or trade contractors may be able to access the experience and wisdom gained from thousands of iterations in spite of only having personally performed or overseen less than a hundred building projects. Such a knowledge base or historical database may also provide the knowledge needed to price a house or other building project upfront based on a historical cost. That is, some embodiments may provide for the historical database to provide an initial estimate in costs and materials to the builder when the builder inputs or otherwise loads the project parameters for a building project. For instance, the presently disclosed technology may farm the historical database to identity and select project parameters similar in scope, to identify submitted bids for said similar project parameters, and to provide the initial estimate to the builder. The present technology may utilize a web price check functionality to form at least a part of the initial estimate. Some embodiments may provide for a historical and/or web price check functionality to be adjusted based on variances in the geographic location of the building project.

Once the builder has accepted a bid, the builder only has to manage its contractors' accountability to agreed-upon tasks and bids in order to meet profit goals.

In various embodiments, the historical database may be an open database, a partially private database, or a private database, or combinations thereof. Past bids and performance for a given contractor may not be shared with other builders and/or contractors. Certain contractors may choose to prevent others from viewing their past bids for building projects so as to protect, for example, their trade secrets associated with their business practices. Other embodiments may provide for a historical database that is openly shared with other entities accessing the presently disclosed technology. For example, a materials supplier may wish to share the price and quality of its materials with builders and/or contractors. Various embodiments may permit the user of the present technology to determine which, if any, of their information and past performance information may be shared.

Clients (e.g., a prospective home or business owner) normally solicit bids from several builders to determine if they can afford to build a project for their original budget estimate. Every client has an ideal budget in their mind up front, and it is usually wrong and usually low. Clients may leverage their contract price down with competitive bidding process in an attempt to meet their original ideal budget. Generally though, movement towards the client's ideal budget usually comes at the expense of the builder's ideal profit potential on a building project. Therefore, it becomes important for a builder to know how much it is going to cost to build a project so they can tender a bid or set a spec house price before construction starts. Standard industry practice is to create the aforementioned estimate using a builder's knowledge base, experience, and the project plans and specifications. Generally, this information may be captured in an excel spreadsheet or in an estimating program maintained by the builder. Protecting profit opportunity can be a frustrating experience when the basis of the job costing process is an estimate of cost over which the builder has no control. An estimate can attract more budget variance and by definition, is not accurate, just an educated guess. These small variances are hard to track without version control and historical data, and can add up to large losses. Many builders lose sight of these and die a slow death of small expenses because they can't track these.

Therefore, it may be important to contract for work and not to rely on an estimate. However, because of the time, effort and complexity required to get it right, it may not be reasonable to contract for work without tools to leverage a builder's knowledge and skill. Various embodiments of the present disclosure may accomplish this.

Rather than addressing the problem of finding the perfect estimating program, the present disclosure may address a problem with an “apples to apples” bid comparison tool. For example, a problem may be knowing with certainty the hard cost to build a project before a quote is tendered or a price is set. The “apples to apples” bid comparison may be a simple, fast, accurate way to arrive at hard costs for a project. Various embodiments of the present invention may provide for breaking down and directly comparing bids among bidding contractors. Such breakdown and direct comparison allows for an “apples to apples” comparison among multiple bids.

For example, the project parameters may be received from the builder specifying certain aspects related to the building project. The project parameters may include a building plan, a scope of work, materials specification, etc. The scope of work may generally define at least a portion of the specifics regarding a building project and its associated building plan, e.g., standards, quality, environmental factors, etc. Bids may be received from several competing contractors. Each bid may include quotes corresponding to various project parameters. While the type of project parameters may be the same (e.g., nails), the quantity of the item may differ from bid to bid. Differences (or discrepancies) may also be found between competing bids with respect to unit price, total price, quality, product specification, etc. As such, there is a discrepancy in the numbers underlying each bid. In order to directly compare such bids, each quote in the received bid is mapped to the corresponding project parameters. The discrepancies among quotes may then be identified. Once the discrepancies are identified, at least one quote may be adjusted or otherwise recalculated based on the discrepancy. Referring to the above example, the number of nails for a first bid may be changed to match the number of nails in one or more other competing bids. The first bid may then be recalculated or adjusted to reflect the changed number of nails. Because the recalculated first bid now reflects the same number of nails as the second bid, the two bids may then be directly compared to each other.

For example, one bid from a contractor may indicate that the contractor can perform the contract using four boxes of 16 penny nails costing $93.40 and 35 (2″×12″×12) boards costing $645.40. Meanwhile another bid from another contractor may indicate use of three boxes of 16 penny nails costing $72.04 and 39 (2″×12″×12) boards costing $719.16. Because such bids rely on different numbers (quantities and prices), it becomes difficult to evaluate and compare such bids, particularly where there are many contractors and many bids. The “apples to apples” bid management provided in the present disclosure allows for automatic breakdown of unit costs, adjustments to the number of units, and recalculation of the total bid based on the adjusted number of units, i.e., adjusting at least one quote based on discrepancies between the quotes. In some instances, the user may designate which number of units (or enter new numbers) to apply to each bid. For example, the user may designate that there are four boxes of nails and 39 frames. The numbers are adjusted for each bid accordingly, and new totals are recalculated. The new totals rely on the same unit numbers and therefore allow for a direct comparison as to which contractor provides the best quote.

Whereas the builder may not have the tools presently available to determine actual prices instead of estimates when providing the client (e.g., prospective home buyer) with a quote, the tools and processes described herein may afford the builder the opportunity to get prices prior to quoting, thus protecting the builder's first and best opportunity to set their profit. The builder's profit potential is always at its greatest risk in the beginning of a building project. If the project is a custom house or a prototype spec house, changes will inevitably occur. Mistakes are also likely to be made as the project progresses, and defects and conflicts in the plans and specifications are discovered. Standard industry practice allows opportunities for the trade contractors to make up profit with outrageous change orders that have not been documented properly or agreed to formally in a trackable manner prior to the work being done, which is the most reasonable time to negotiate a reasonable price. Various features described herein may provide the ability to document and quote in real-time, from the field, from mobile devices, etc., and to easily load such documentation into contracts, budgets, and work orders. The builder may therefore negotiate a fair price for the work prior to performance, rather than be held hostage to what the contractor desires in margin after the job has already been performed. This embodiment can mostly replace the current verbal and undocumented process the builders most often use currently.

Bid management may also include presenting the bids in tables with the lowest bids and/or lowest units highlighted or otherwise displayed in a manner to draw attention or otherwise denote such low bids/units to the builder. Similarly, adjusted numbers may be highlighted to indicate that they have been adjusted. The builder may also request, via a low price generator, the lowest prices by item and quantity. The knowledge base and intelligent analysis of the same may also indicate, for example, that quantities of nails and number of boards can vary due to error or variances in construction processes. Items, such as the number of windows and doors and their sizes, should always be consistent amongst bidders. In some embodiments, the builder may request a web search for available prices. Such prices may also be compared to the quotes provided by bidding contractors.

In some instances the builder may have a preferred vendor or set of vendors. Utilizing the Last Look™ function, the builder has the option to designate such preferred vendor(s) and allow them the opportunity to match the lowest bid(s). For example, a particular builder may prefer to work with a nail supplier with particularly excellent service or quality of product. Where that supplier did not provide the lowest bid, however, the builder may nevertheless wish to work with the supplier if the supplier can lower its bid to match the lowest bid. The opportunity to match may be sent to the supplier automatically or upon request by the builder.

Such an “apples to apples” bid comparison tool may allow for version controlled budgets, which further may allow for goal-setting with respect to the cost of a house and collaboration with contractors to value-engineer the plan prior to starting work. Such a tool may leverage both builder and trade expertise in their respective fields and may further allow for tracking progress not just through the contracting phase, but also through the construction phase. Version control is extremely difficult and almost unachievable using currently available tools, but is also very important towards setting a goal budget and ultimately having the visibility to meet costs in the implementation phase of the contracts and budgets.

Users, e.g., builders and trade contractors, may access such services by logging into a web service. The web service may determine the status of the builder or contractor and provides additional services based on the status. To log in, a user login may be submitted through a login page and compared to stored information regarding an existing user account. In some cases, a new user account may be created and stored in memory for future reference. The user account may include information regarding the status of the membership, demographics, duration of the membership, or the contracts performed. Certain embodiments may provide for all users logging in from the same page. Initial user types may be Administrator, Real Estate Developer, Builder, Trade Contractor, Builder Office Administrator, Trade Contractor Office Administrator, Builder Insurance Agent, Trade Insurance Agent, Attorney, Banker, CPA, Realtors/Sales Person, Supply Chain Advertisers, Documents Seller, as well as Independent Homeowner seeking contractor services. For anyone that is a member, their profile may denote how many months they have been a member and include changing profile names based on how long they have been there and then how many contracts they have done. For example, 1000 jobs may make them a master trade contractor, etc. Also, various embodiments may provide for including their ratings from other builder's, users, or trade contractors in their profile. That is, as a user maintains and updates his or her account, the profile name associated with the user account may change, for example, based on the status information received from the user. Additionally, rewards or discounts may be given based on the type and status of the account user. Users may be able to form buying groups on forums or educational/experience/advice teams where non-competitors share experience to seek synergy. Various embodiments may also provide for a rating system wherein users can be rated by other users based on their performance characteristics. Builders may be able to rate contractors, and contractors may be able to rate builders, thereby negating the role of habit and relationship which may play a role in preventing competitive pricing. Fears regarding quality and experience (or lack of) with respect to previously un-used contractors may be mitigated through such ratings in the building community.

Various embodiments may also provide for the display of advertisements to be presented during utilization of the present technology. Such advertisements being displays puts the most relevant and critical information before the decision makers at the time the decisions are being made. The advertisement may be targeted to a particular situation. Some aspects may provide for a materials supplier or contractor to display a targeted advertisement to a builder using the present technology. When a builder is entering project parameters for a building project, the targeted advertisement may be provided by a contractor and displayed to the builder on the same screen. For example, when a builder is entering the project parameter defining the nails required by the building project, a materials supplier may provide an advertisement quoting a price for nails to the builder in the hopes the builder will select or otherwise activate the advertisement and select the materials provider. Such a targeted advertisement may also be provided to the builder when reviewing a received bid from other contractors. For example, when a builder is reviewing the received bids to determine the quoted price for nails, the targeted advertisement may be displayed or otherwise provided to the builder from a materials supplier quoting a lower price for nails. Various embodiments may provide for the contractor providing the advertisement to have access to at least a portion of the project parameters the builder is entering and/or reviewing so as to provide an advertisement directly related to said project parameter. In some embodiments, the advertisement may also be readily converted into a contract between the two parties based incorporating the parameters from the bid.

Various embodiments may also provide for displaying an advertisement provided by a manufacturer or a supplier to a contractor. The advertisement may be provided to the contractor when the contractor is entering or otherwise providing the quotes for the bids. For instance, the present technology may provide for determining when a contractor is entering the quantity/quality/price/etc. quote for nails in order to submit a bid to a builder and concurrently provide an advertisement from a nails supplier to the contractor. The present technology may provide for determining the price the contractor is entering into the quote and selecting an advertisement from a nails supplier that is less than the entered price. Other embodiments may provide for providing the advertisement to the contractor from a preferred supplier. Some embodiments may provide for the advertisement to be readily converted into a contract between the two parties based incorporating the parameters from the bid. In one example, the advertisement may include an “Accept” button or mechanism wherein the contractor selecting the “Accept” button may form the contract.

Once a builder identifies the winning contractor using the herein described technology, the builder may select that contractor to thereby award the contract. Various embodiments may provide for a database of contracts having applicable contracting language wherein once the builder selects the winning contractor, a contract is thereby automatically formed therebetween. During the constructions process, the contract may be mutually updated between the builder and contractor as agreed upon changes are encountered.

It is to be understood that aspects of the present technology may be scalable to meet a particular situation. In one example, the presently disclosed inventive concept(s) may be implemented as a series of web pages accessible to any number of builders, contractors, and the like, wherein each user may or may not have a relationship together. That is, implementation via a series of web pages may permit a group of builders and contractors to utilize the present technology in New York City and simultaneously permit a separate group of builders and contractors in San Francisco to utilize the same technology. In other embodiments, the present technology may be implemented as a computer program stored and executed on a personal computer or portable device by a builder (e.g., a mobile app on a smart phone). In this embodiment, the builder may receive the bids from the contractors via, for example, email and then load or import the bids into the program. Other aspects may provide for the builder receiving the bids in a paper form and then manually entering the bids into the program or scanning the bids and utilizing optical character recognition software to load or import the bids into the program.

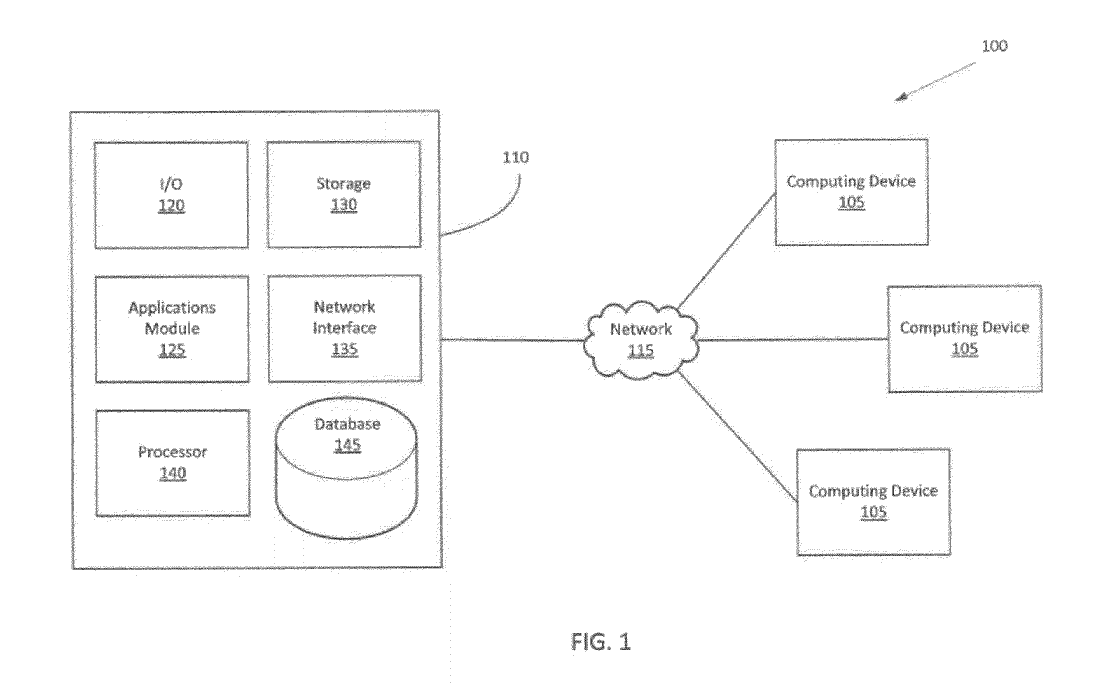

These and other function and implementation details regarding the systems and methods of the presently described and claimed inventive concepts will be described in greater detail below with reference to the FIGS. 1-16.

Referring now to FIG. 1, shown therein is an exemplary architecture 100 of a system which may be adapted to practice aspects of the present disclosure. That is, the exemplary architecture illustrated in FIG. 1 includes hardware, software, and/or combinations thereof, adapted to implement certain aspects of the presently disclosed and claimed inventive concept(s). The exemplary architecture is provided by way of example only and is not intended to be limiting. Changes and variations to the exemplary architecture illustrated in FIG. 1 are considered within the scope of the present disclosure.

A module (or application), as referenced in the present invention, should be generally understood as a collection of routines that perform various system-level functions and may be dynamically loaded and unloaded by hardware and device drivers as required. The modular software components described herein may also be incorporated as part of a larger software platform or integrated as part of an application specific component.

The system 100 illustrated in FIG. 1 includes one or more computing devices 105 (three being shown in FIG. 1 by way of example) coupled to a processing system 110 via a network 115. The system is not limited to three computing devices 105, other numbers of devices may be used. Although FIG. 1 shows one processing system 110 communicating through the network 115 with three computing devices 105, it is to be understood that the system 100 can include more than one processing system 110 (e.g., more than one server or a distributed server arrangement) communicating with more or less computing devices 105.

Generally, the computing device 105 may be associated with one or more users, e.g., one or more of a client, a builder, a contractor, etc. The computing device 105 may be adapted to permit the user to communicate, or otherwise interface with the processing system 110, via the network 115. The computing device 105 can include component(s), logic instructions, and/or combinations thereof, adapted to permit the user to interface with the processing system 110 to, for example, 1) provide project parameters and bids to the processing system 110, 2) display an advertisement to the user using computing device 105, 3) request an updated bid, and/or 4) permit the user to accept a bid from a contractor using the processing system 110 via the network 115.

The computing device 105 may be adapted to permit the builder or contractor to interface with the processing system 110 using, for example, a web browser, to access project parameters and/or bids over the network 115. The project parameters, bids, and historical database may be stored on the processing system 110 rather than being downloaded to the computing device 105. The builders or contractors may access the processing system 110 through and using, for example, a series of web pages accessible via the web browser operating on the computing device 105. The computing device 105 may include components, logic instructions, and/or combinations thereof adapted to record, associate, or otherwise provide project parameter, a bid, etc., to the processing system 110.

In yet another aspect, the computing device 105 can be adapted to permit the builder and/or contractor to interface with the processing system 110 via the network 115 to download the information relating to the building project to the computing device 105 and to then upload or otherwise provide the project parameters, bids, bid selection, etc., to the processing system 110.

The computing device 105 may include any computerized system that can implement a web browser application or other suitable applications adapted to request and provide information to and from the processing system 110 via the network 115. Exemplary systems adapted to implement the computing device 105 include, but are not limited to, a general purpose computing system, a personal computer, a laptop computer, a netbook, a personal digital assistant (PDA), a smart phone, an e-reader, and/or equivalents thereof. Exemplary software applications included on the computing device 105 include a web browser application, a word processor application, a time keeping/tracking application, a communication application, as well as a wide variety of applications understood by one having ordinary skill in the art.

Broadly, the network 115 may be adapted to provide a communications medium to permit the one or more computing devices 105 to communicate with the processing system 110, and vice versa. The network 115 can be implemented via the World Wide Web (WWW), a wide area network (WAN), a local area network (LAN), the Internet, a wireless network, a cellular telephone network, and/or equivalents or combinations thereof.

The processing system 110 may include component(s), logic instructions, and/or combinations thereof, adapted to implement at least a portion of the currently described and claimed inventive concept(s). The processing system 110 may include instructions stored on non-transitory computer readable medium that when executed causes the processing system to implement the present technology.

As shown in FIG. 1, the processing system 110 may include an input/output (I/O) module 120, an applications module 125, a storage module 130, a network interface module 135, a processor 140, and one or more databases 145. The I/O module 120 includes hardware, logic, and/or combinations thereof that may permit an administrator to interface, operate, or otherwise control the processing system 110. Exemplary components included as a part of the I/O module 120 may include a keyboard, a mouse, a monitor, a pointing device, a printer, a scanner, and equivalents and/or combinations thereof.

The applications module 125 may include one or more of programs, applications, logic instructions, and computer executable code adapted to operate the processing system 110 as well as to carry out at least a portion of the currently described and claimed inventive concept(s). The storage module 130 may store, for example, the programs and/or applications, operating protocols, and the like, as well as a variety of other processing system 110 parameters, as would be understood in the art. The network interface module 135 may be adapted, or otherwise configured to enable the processing system 110 to communicate via the network 115. The processor 140 may include components, logic instructions, and/or combinations thereof adapted to generally operate the processor system 110.

The database 145 may include, for example, information relating to one or more of the project parameters for a building project (e.g., building plan and scope of work), bids, historical database, etc. Although shown as a single database, the database 145 can be implemented as a plurality of internal or external databases, e.g., a relational database, object database, and the like.

It is to be understood that the description provided above regarding the particularities of the exemplary architecture implementing the processing system 110 is provided by way of example and is not to be considered limiting. The processing system 110 may be implemented as described above or with a variety of modifications and/or changes to the architecture without departing from the particular functions described herein. For example, the processing system 110 may be implemented as a stand-alone server, as a web server, as a distributed server system, as an application server, in combination with a database server, etc. When the processing system 110 is implemented as a webserver, the processing system 110 may communicate with the computing device 105, via the network 115, through a series of web pages. The processing system 110 may be implemented as a single web server or as a distributed processing system including a plurality of server(s) coupled to one or more databases, either locally or remotely.

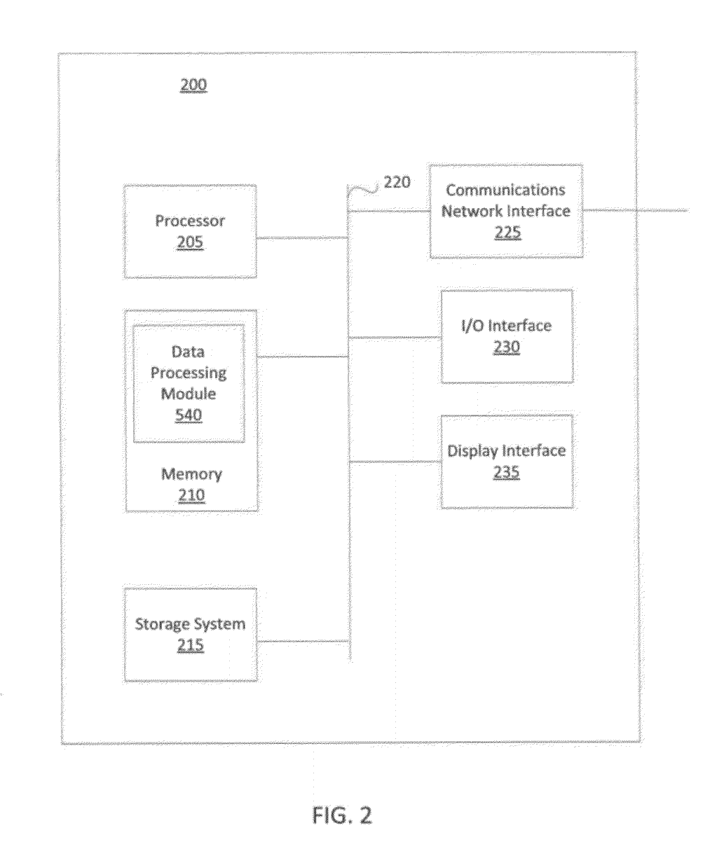

FIG. 2 is a block diagram of an exemplary system 200. System 200 may be used to implement computing device 105 of FIG. 1. The system 200 may include one or more processors 205 and memory 210. The memory 210 may store, in part, instructions and data for execution by the processor 205. The memory 210 may store executable code when in operation. The memory 210 may include a data processing module 240 for processing data. The system 200 may further include a storage system 215, communication network interface 225, input and output (I/O) interface(s) 230, and display interface 235. The components shown in FIG. 2 are depicted as being communicatively coupled via a bus 220. The components may be communicatively coupled via one or more data transport means. The processor 205 and memory 210 may be communicatively coupled via a local microprocessor bus, and the storage system 215 and display interface 235 may be communicatively coupled via one or more input/output (I/O) buses. The communications network interface 225 may communicate with other digital devices (not shown) via a communications medium.

The storage system 215 may include a mass storage device and portable storage medium drive(s). The mass storage device may be implemented with a magnetic disk drive or an optical disk drive, which may be a non-volatile storage device for storing data and instructions for use by the processor 205. The mass storage device can store system software for implementing embodiments according to the present technology for purposes of loading that software into the memory 210. Some examples of the memory 210 may include RAM and ROM. A portable storage device, as part of the storage system 215, may operate in conjunction with a portable non-volatile storage medium, such as a floppy disk, compact disk or digital video disc (DVD), to input and output data and code to and from the system 200 of FIG. 2. System software for implementing various embodiments may be stored on such a portable medium and input to the system 200 via the portable storage device. The memory and storage system of the system 200 may include a non-transitory computer-readable storage medium having stored thereon instructions executable by a processor to perform, at least partially, a method for determining a proportional payment to each contributor of a collaborative work. The instructions may include software used to implement modules discussed herein, and other modules.

I/O interfaces 230 may provide a portion of a user interface, receive audio input, and provide audio output. The I/O interfaces 230 may include an alpha-numeric keypad, such as a keyboard, for inputting alpha-numeric and other information, or a pointing device, such as a mouse, trackball, stylus, or cursor direction keys. The display interface 235 may include a liquid crystal display (LCD) or other suitable display device. The display interface 235 may receive textual and graphical information, and process the information for output to the display interface 235.

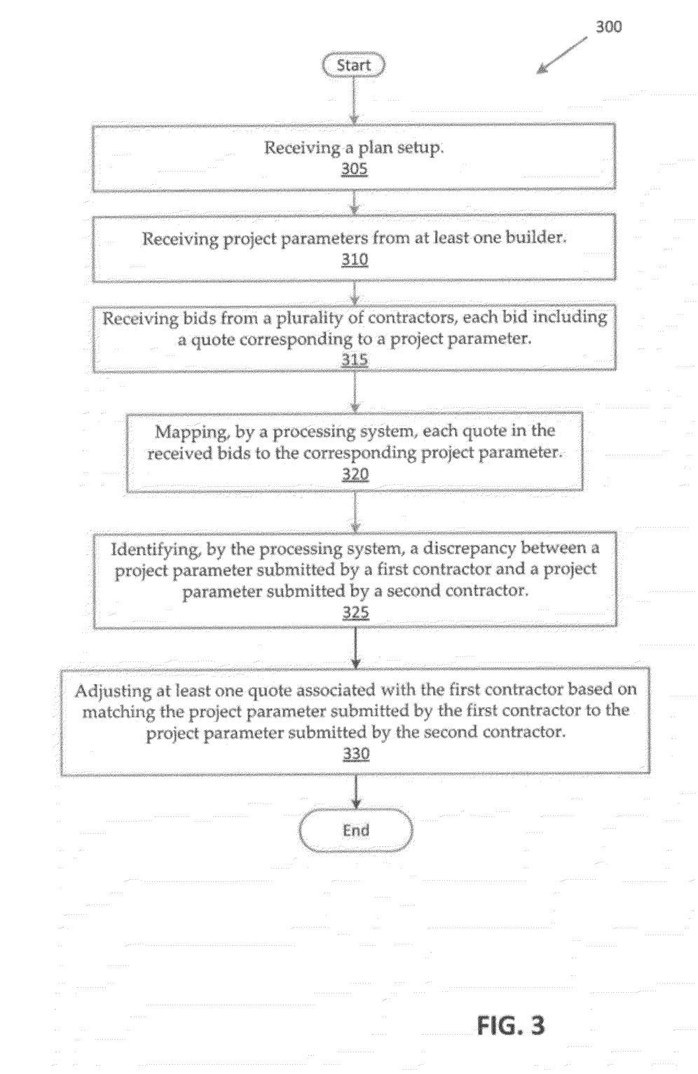

FIG. 3 is an exemplary flow diagram of a method 300 for managing contracts. Generally, the steps of the method 300 may be performed by the processing system 110 and/or the system 200. One of ordinary skill in the art will appreciate that the processing system 110 can be implemented as a plurality of web servers, i.e., the steps of the method 300 may also occur on one or more web servers, one or more presentation servers, or across a distributed computing system such as a cloud computing system, and the like.

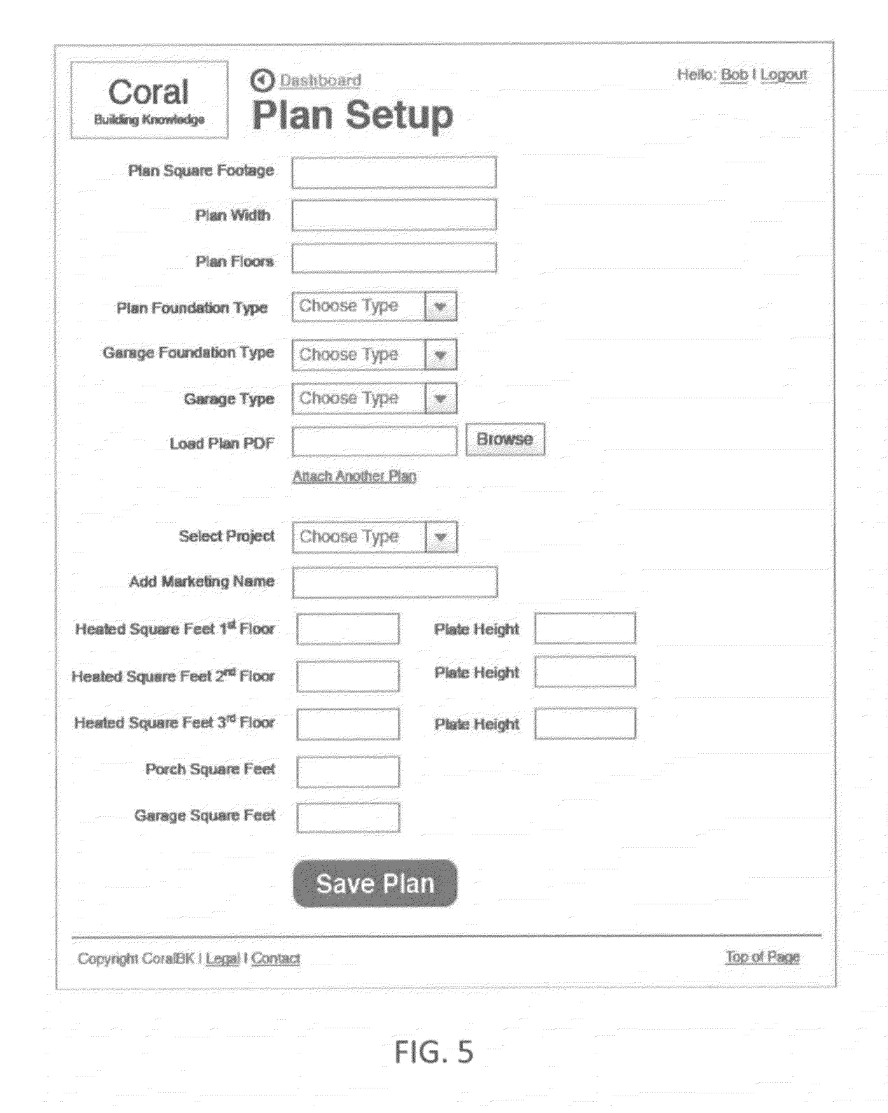

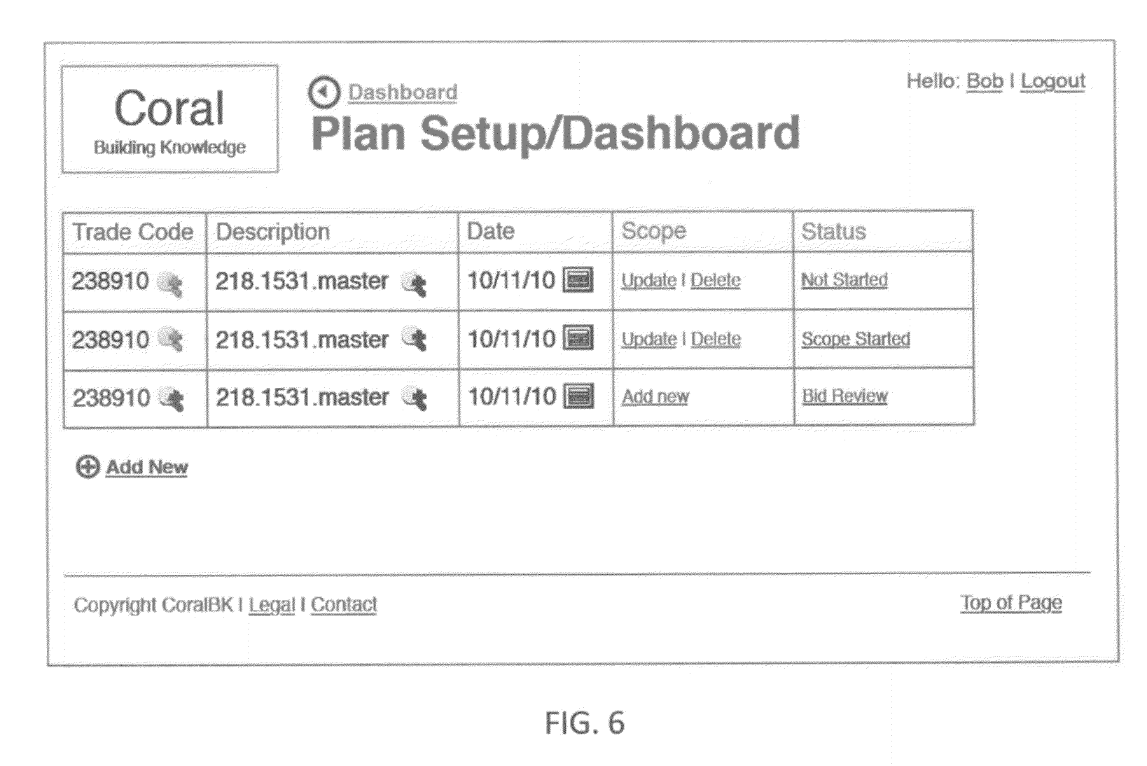

The method 300 may include the step 305 of receiving a plan setup. The plan setup may be received from a builder and may contain data or information relating to, for example, a building project plan. Certain aspects may provide for receipt of a plan setup via uploading a file to a website employing, for example, the processing system 110 via the network 115. Various embodiments may provide for receipt of the plan setup via a series of one or more web pages. Exemplary web pages can be found in FIGS. 5 and 6 (discussed below).

The method 300 may include the step 310 of receiving project parameters from at least one builder. The project parameters may include information or data relating to, for example, a building plan, scope of work statement, etc., relating to a contract. The project parameters may be received electronically (e.g., via the network 115) and loaded or otherwise entered into the processing system 110. Some embodiments may provide for receiving the project parameters in hard copy wherein a user or administrator loads or otherwise enters the project parameters into the processing system.

The method 300 may also include the step 315 of receiving bids from a plurality of contractors, each bid including a quote corresponding to a project parameter. The bids may include quotes corresponding to project parameters for a building project. For example, quotes may include a quantity, quality rating, price, etc., for items and/or services for the building project. In some embodiments, the processing system 110 may receive the bids via the network 115 from contractors using the computing device 105. The present technology may further provide a mechanism to store the bids received from contractors. The processing system 110 may provide for storage of the bids, as well as the associated information, in, for example, the database 145 and/or the storage 130.

The method 300 may further include the step 320 of mapping, by a processing system, each quote in the received bids to the corresponding project parameter. The processing system may be implemented as the processing system 110 and/or the system 200. The processing system may be configured to analyze or otherwise identify information contained in each of the quotes in the received bids and then map the information to the corresponding project parameters. In one example, the processing system 110 may identify a line item in the bid as corresponding to the quality, quantity, and price for nails required by the project parameters and entering or otherwise mapping said information with the corresponding project parameter.

The method 300 may further include the step 325 of identifying, by the processing system, a discrepancy between a project parameter submitted by a first contractor and a project parameter submitted by a second contractor. Some embodiments may provide for comparison of the quotes received in the bids so as to identify discrepancies between the quotes. In the example discussed above, the processing system can identify when a first contractor indicates in his quote that three boxes of nails are required when the competing contractors indicate that four boxes of nails are required.

The method 300 may further include the step 330 of adjusting at least one quote associated with the first contractor based on matching the project parameter submitted by the first contractor to the project parameter submitted by the second contractor. In the example discussed above, the bid received from the first contractor can be adjusted to indicate that four boxes of nails are required.

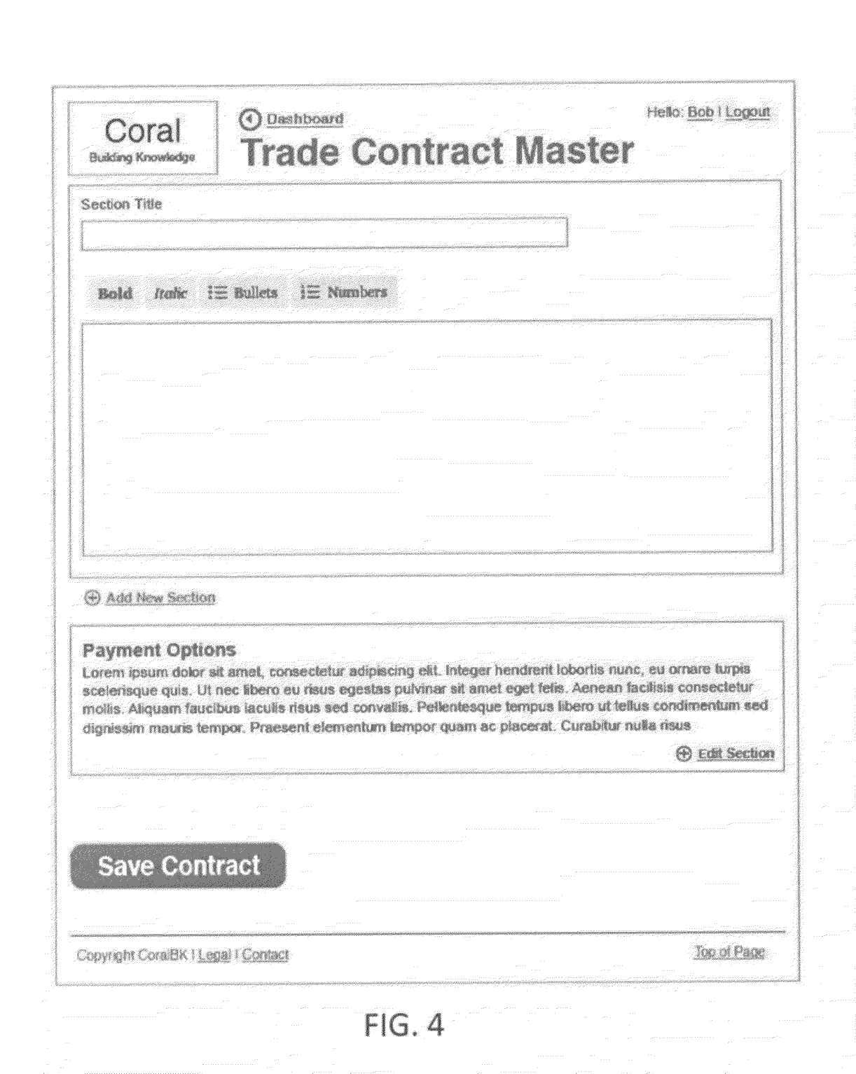

Referring now to FIGS. 4-16, shown therein are exemplary screen shots embodying various aspects of the present disclosure. As discussed above, various embodiments may include several modules that provide services as part of the web service.

FIG. 4 shows an exemplary screen shot from Trade Contract Master module that may be used to customize the language and terms of a Trade Contract according to information received from a setup plan. Generally, the Trade Contract Master module may provide the ability to set payment terms, alter general language easily, adjust conservative to aggressive spectrum of the language in the Trade Contract. Various embodiments may provide for the Trade Contract Master module to load or otherwise control all Trade Contracts when a plan (e.g., a building plan) is setup. The Trade Contract Master module may also filter the contract language based on a parameter, which may relate to different contract terminology settings. For example, a lower setting of “protect my cash” may provide fewer contract terminology filters while a higher setting of “protect me from lawsuits” may provide more contract terminology filters. The parameter may be set by the account user or have a default setting. A user may access, modify, and sell Trade Contracts.

There may also be a “help” mechanism related to the content in the paragraphs of the trade contract that, when engaged, provides a layman's explanation of the contract terms. Such a feature may allow the builder to hold the contractor (or supplier, materials manufacturer, etc) to the bid. A key aspect of the step may be a payment based on the contract rather than an invoice. In contrast, the current process involves agreeing to a contract price, but the contractor may end up sending a bill for contractor costs plus desired profit without any accountability for the contracted price, thus putting the risk of poor cost management on the builder.

The Trade Contract Master module may contain a Lawyer Franchise Opportunity module which allows the account user to access and modify the trade contract by state and by client. The account user may also sell their Trade Contracts and Scopes of Work documents through a Document Store module provided by the present system. The Trade Contracts and Scopes of Work may be automatically loaded into Trade Contract Master for other account users to access and use.

A Lien Waiver Master module may create a waiver and a Scope of Work Master to customize the scope of the work language. The Lien Waiver Master module and the Scope of Work Master module may also contain the features of the Trade Contract Master module, or may be implemented separately. The user may be educated as to the importance of receiving lien waivers and how to effectively implement them.

FIG. 5 illustrates a Plan Setup Screen that facilitates creating a new plan, e.g., a building plan having project parameters. The plan may include information regarding the Trade Contracts, Scope of Work, and Bids. The Plan Setup Screen may also have a Create Standards and Specification Sheet to assist in selecting various building materials. This information may also be available as a part of the contract package by trade code and/or task code. The web service may use a global list of Trade Codes and/or Task Codes to allow quick yet thorough generation of a budget template for bidding purposes. Once the builder has created a template for use on one plan, such a builder will have the ability to load that template to any future plans by assigning a name and version to that template.

FIG. 6 illustrates an exemplary Plan Setup Dashboard which may provide information on the Trade Codes. The Trade Codes information may include the trade code description, estimated duration, lead time and trade code status. The Plan Setup Dashboard may also provide information regarding requesting a bid option by trade/trade code, an Active for Trade Contracting Bid/Bid option, and a Finished with Setup option. The Active Bids may be accessed by selecting one of these options. The Plan Setup Dashboard may allow for a user to edit and search trade codes and other information, add new trade codes, and manage trade contractors. The lead time provided by the contractors as a part of their bids can be used to automatically generate a construction schedule.

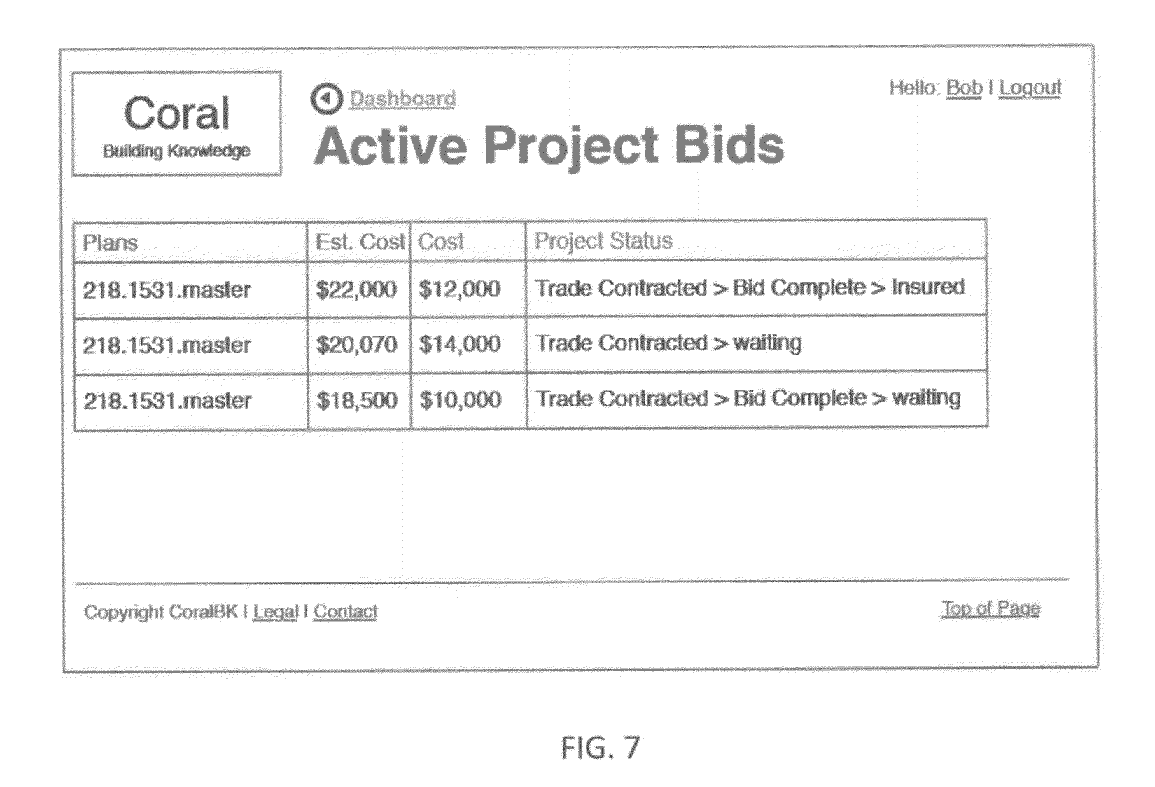

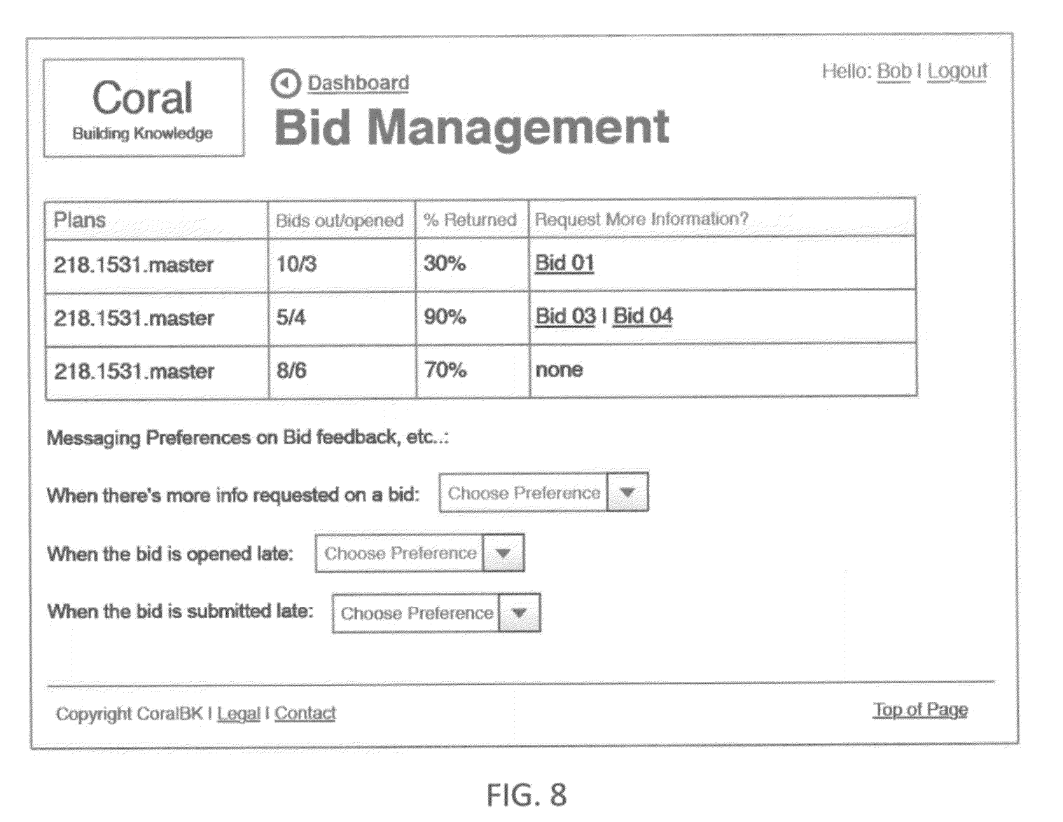

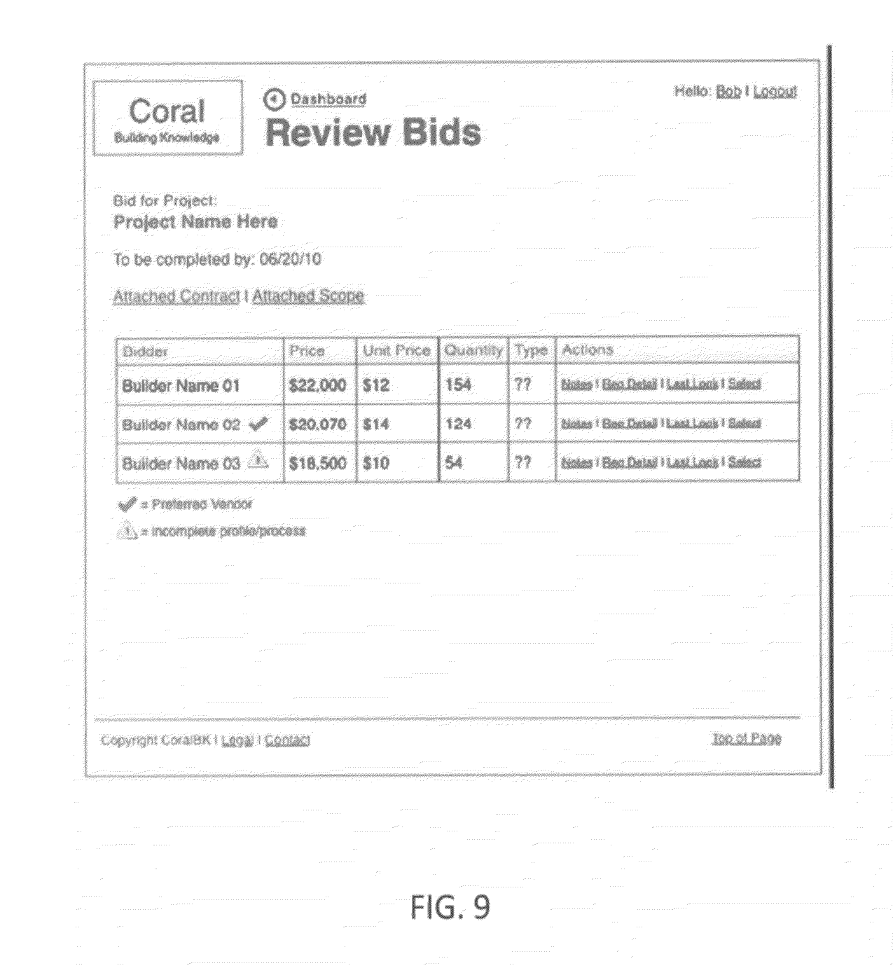

Bids may be managed in several aspects. FIG. 7 illustrates an exemplary Active Project Bids module which may allow the account user to view active plans and active plans status. An exemplary Plan Bid Management module illustrated in FIG. 8 may list the plans including the various bidding stages, status of each plan-percentage opened, percentage of bids returned, and bids with additional information request. An exemplary Review Bid module illustrated in FIG. 9 allows the user to manage, evaluate, compare and edit the project bids.

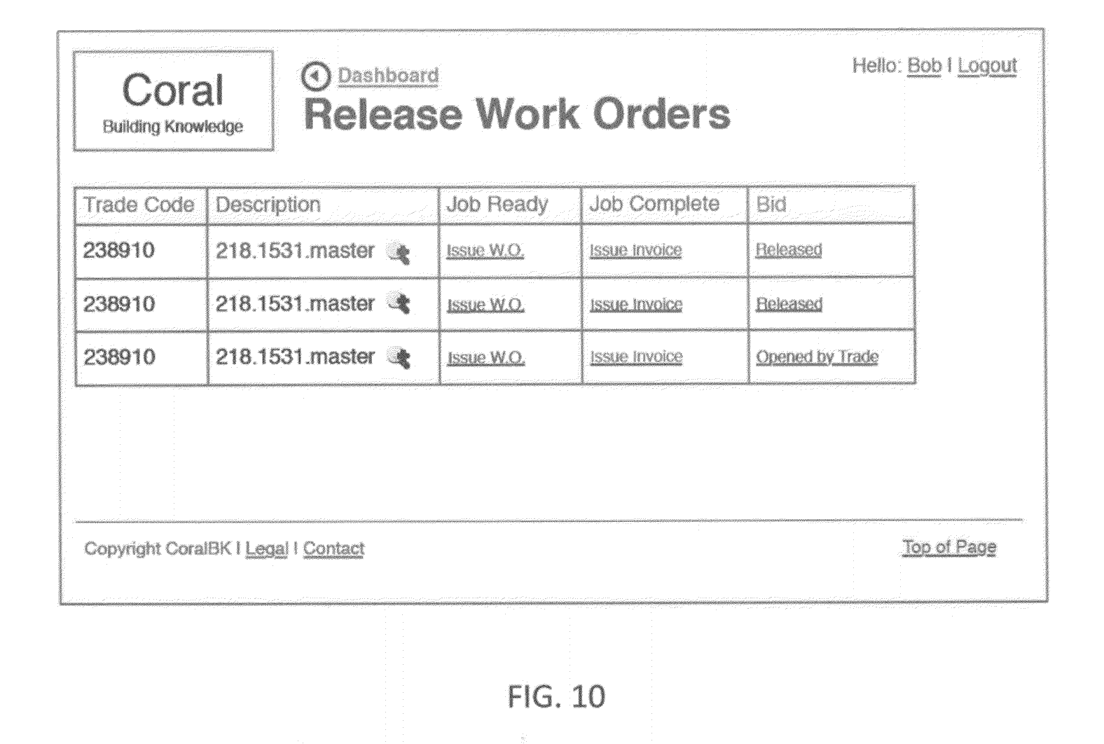

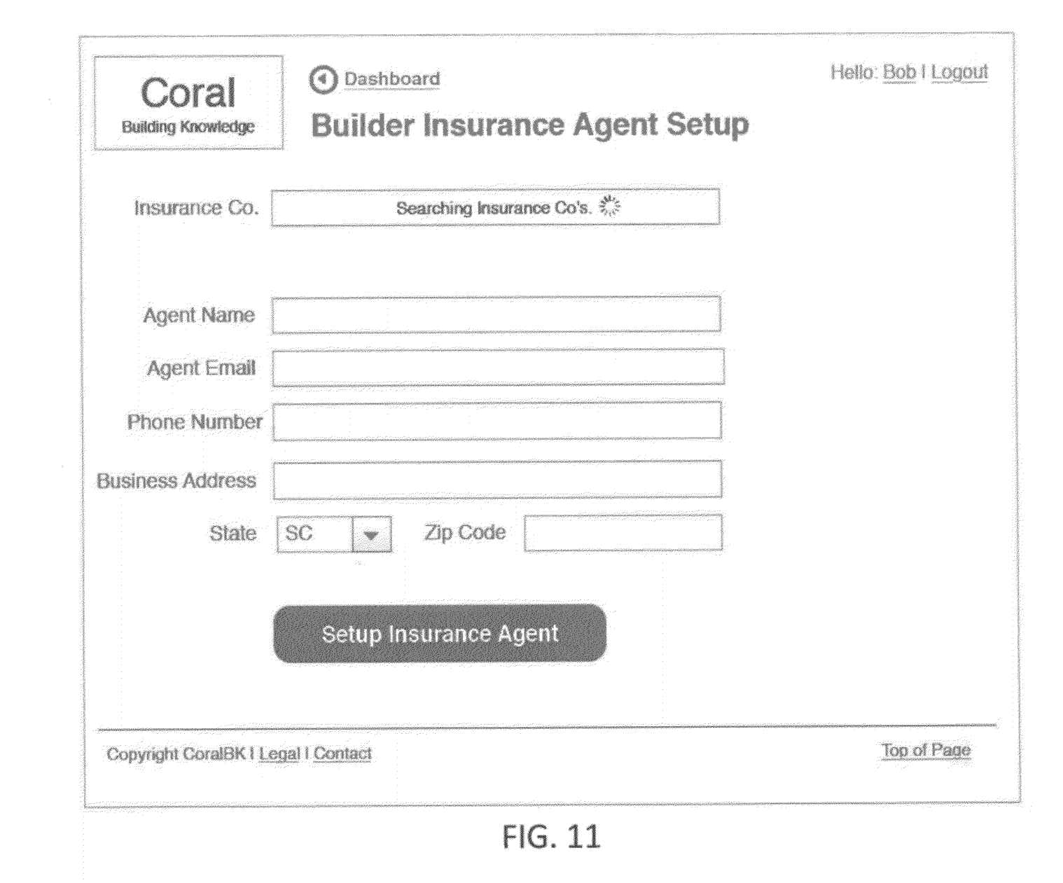

Other features of the present invention may relate to work orders and insurance management. An exemplary Release Work Orders module illustrated in FIG. 10 provides job ready/job complete status as well as Trade Codes for a plan with awarded bids. An exemplary Builder Insurance Agent Setup module illustrated in FIG. 11 allows an account user to enter and manage builder insurance information such as payment milestones and policy effectiveness dates, and may not allow a contractor to request payment without a valid in-force insurance policy. The web service may automatically request from contractors and/or their agents to verify that the policy is still in-force at set intervals prior to its expiration to help prevent policies from ever lapsing. Reports for the builders' insurance company to audit the effectiveness of such policy management and enforcement tools may also be included.

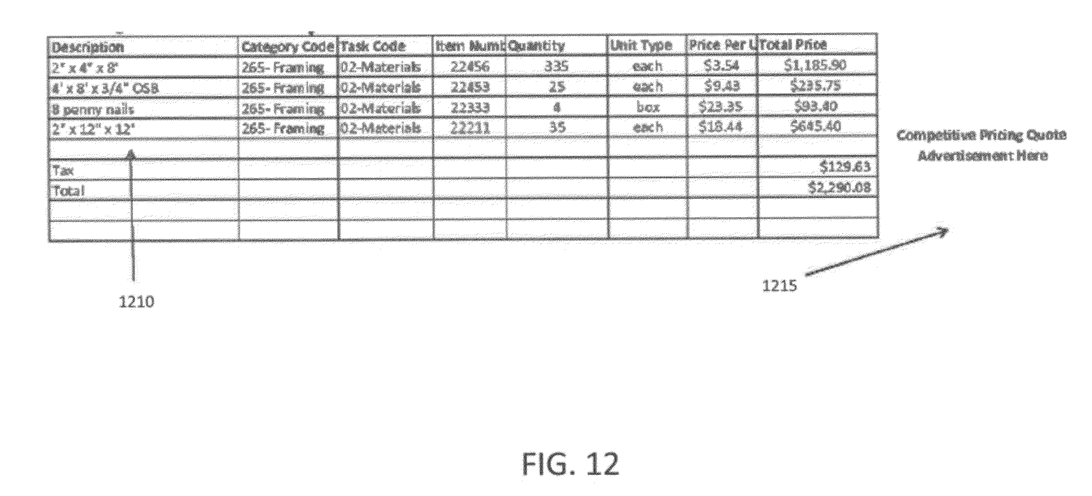

Referring now to FIGS. 12-16, shown therein are exemplary screen shots depicting certain aspects related to the “apples-to-apples” functionality discussed above. Broadly, said functionality maps each quote in the received bids to corresponding project parameters, identifies discrepancies in the quotes between differing contractors, and adjusts at least one quote based on the discrepancy.

FIG. 12 illustrates a screenshot of an exemplary bid received from a contractor named 3A Framing. At 1210, the Description row expands to show more detail for exact product specifications from, for example, the manufacturer. The Description row or product specifications can be set in any of the screens to be the desired material required by the builder/contractor. When set, updates will be sent out to bidding entities. The Description row can include a link to the full product specifications on the manufacturer's website. At 1215, various embodiments may provide for a supplier/contractor to provide an advertisement to builders while the builder is setting up/entering the project parameters or when the builder is reviewing bids received from contractors. The supplier/builder may provide the advertisement based on the trade and/or task code the builder is entering/viewing.

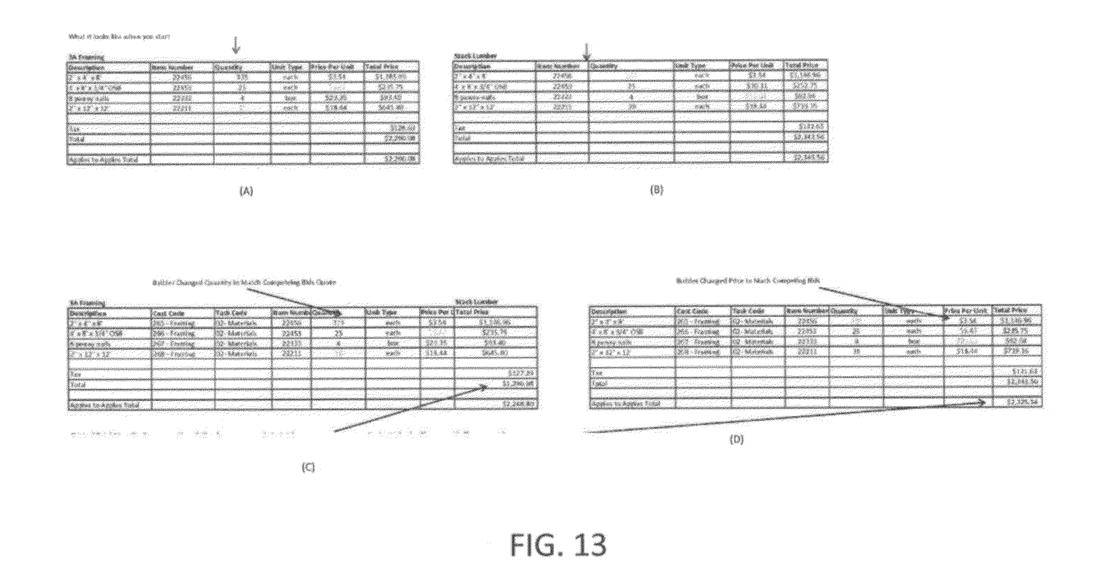

FIG. 13 illustrates exemplary screenshots showing the apples-to-apples functionality and also how identified discrepancies may be displayed or otherwise communicated to the builder. Generally, discrepancies (e.g., low prices, quantities, etc.) may be highlighted or otherwise brought to the builder's attention by changing the corresponding portion of the quote. For example, the discrepancy can be denoted by making the entry bold, italicized, flashing, etc., or by changing the pitch, font, or color for that entry. Turning to FIG. 13, two competing bids are shown therein, the first identified at (A) is from contractor named 3A Framing and the second identified by (B) is from contractor named Stack Lumber. In the two bids, the quantities for various components are different as well as the Price Per Unit. In the example shown in FIG. 13, the Quantity of 2″×4″×8′ is 335 for 3A Framing and 308 for Stack Lumber. Therefore, the quantity for said 2″×4″×8′ is highlighted or otherwise denoted in the bid from Stack Lumber. Similarly, other differences between the two bids are highlighted or otherwise denoted for the builder. Various embodiments may provide for matching numbers between the bids to remain a first color (e.g., black). Also, high numbers may remain black. A low bid, a low price, and low units may be denoted in Green. Various embodiments may provide for a builder to adjust the quantities in the bids so as to compare the impact the adjustment will have on the total price compared to the competing bids. Changes in quantity, unit price, descriptions, etc., may be denoted in red and also two totals may be shown at the bottom. The builder may also adjust the price per unit on the bids so as to compare the impact it will have on the total price compared to competing bids. A materials cost search and quoting function may also be provided wherein the builder and/or contractor can access, for example, the Internet so as to look up available pricing for components. Said function may be accessible by clicking on the applicable product.

At (C) and (D), the builder has changed to discrepancies (e.g., quantities, prices, etc.) between the competing bids so as to accomplish the apples-to-apples comparison between the bids. Pricing updates may also be provided wherein the original total price from each contractor is maintained and an apples-to-apples price total is also added to the bid so that the builder can then compare the competing bids on an apples-to-apples basis.

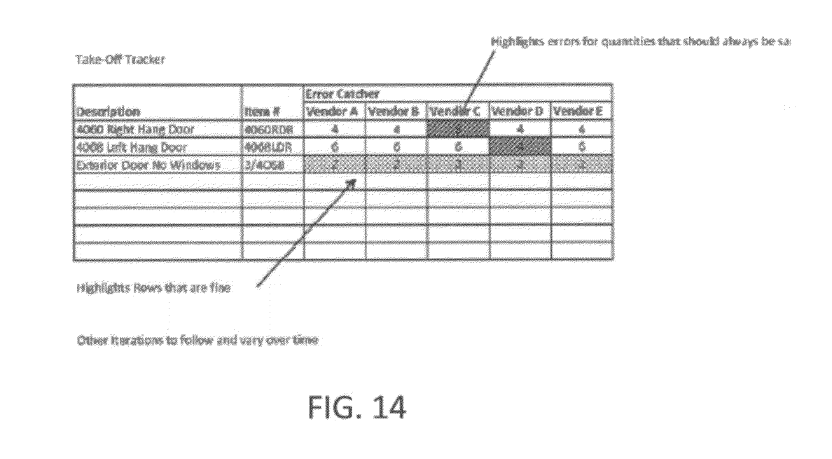

FIG. 14 is an exemplary screenshot illustrating a Take-Off Tracker function provided in accordance with the present disclosure. Certain project parameters within a particular building project should always be consistent. For example, the quantity of doors, windows, etc., should be consistent between competing bids for a given building project. The Take-Off Tracker shown in FIG. 14 highlights discrepancies or other inconsistencies between competing bids for such project parameters. As shown therein, Vendor C has provided a bid for 4060 Right Hang Door with a quantity of 3, wherein the remaining bids from the other contractors each have a quantity of 4. Such discrepancies are highlighted so as to bring them to the attention of the builder. For products with a consistent quantity between competing bids, the rows may be highlighted as well.

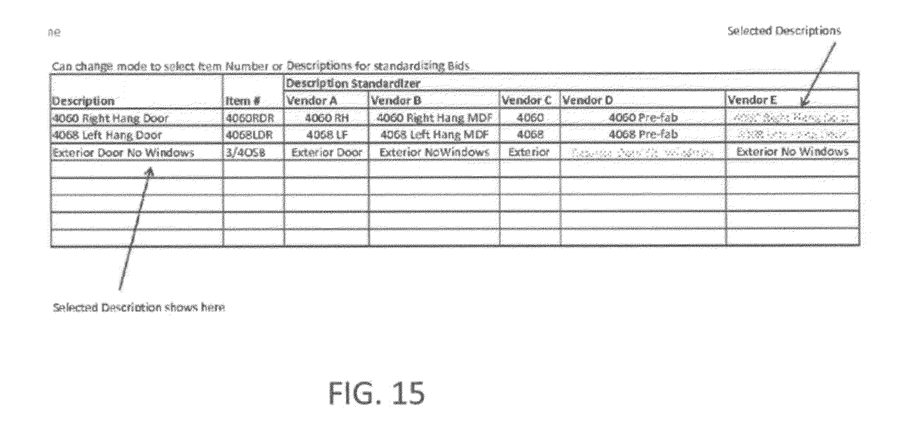

FIG. 15 is an exemplary screen shot of Bid Standardizing function provided in accordance with the present disclosure. The builder can select the Bid Standardizing Function wherein, by selecting a description of a product from a preferred vendor, the Description of the product is changed to match the selected vendor's description.

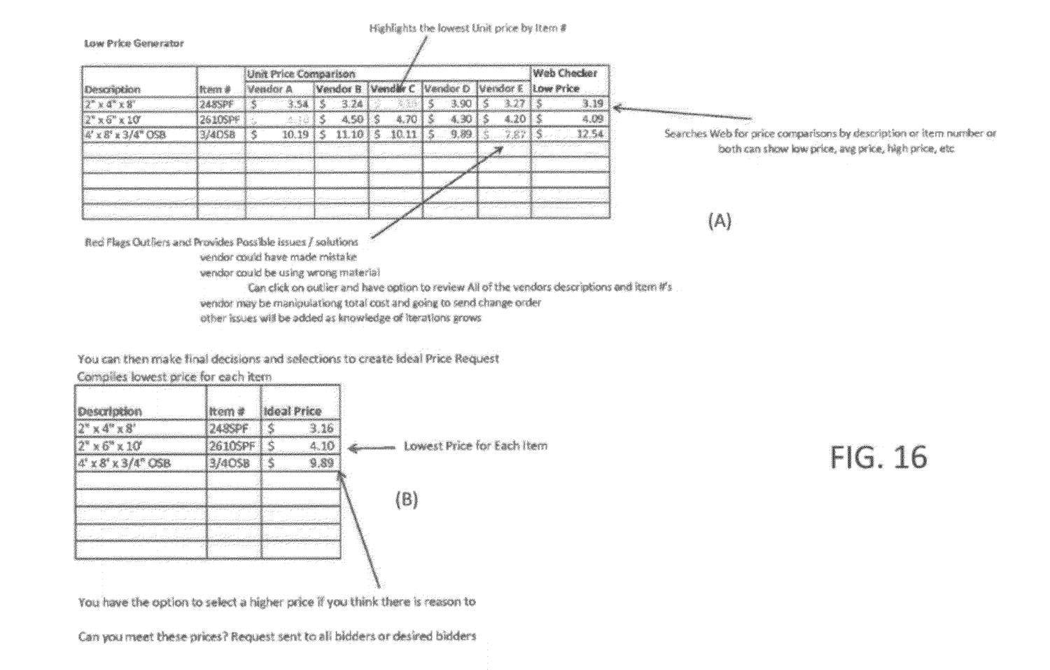

FIG. 16 is exemplary screen shots of a Low Price Generator function provided in accordance with the present disclosure. At (A), the present technology displays a spreadsheet wherein each row depicts a product according to the project parameters and each competing vendor price is provided for each product. The lowest price for each product may be highlighted as well as any potential outliers or issues. Such issues may be that the bidding vendor/contractor may have just made a mistake, using the wrong material, manipulating total cost, etc. A web search function may also be provided wherein the present technology searches the internet to determine the lowest price for each product. At (B), the lowest price for each item is compiled into a table for the builder. The builder may then be provided with an option to request an updated bid from all of the competing contractor or a preferred contractor using the lowest prices.

While the present invention has been described in connection with a series of preferred embodiments, these descriptions are not intended to limit the scope of the invention to the particular forms set forth herein. The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. The present descriptions are intended to cover such alternatives, modifications, and equivalents as may be included within the spirit and scope of the invention as defined by the appended claims and otherwise appreciated by one of ordinary skill in the art. In several respects, embodiments of the present invention may act to close the loopholes in the current industry practices in which good business practices and logic are lacking because it is not feasible to implement with current resources and tools.

What is claimed is:

1. A system comprising:
a memory for storing executable instructions for managing contract bids; and
a processing system configured to execute the instructions stored in the memory, wherein executing the instructions causes the processing system to:
receive project parameters from at least one builder;
receive bids from a plurality of contractors, each bid including a quote corresponding to a project parameter;
map each quote in the received bids to the corresponding project parameter;
identify discrepancies between the mapped quotes, and
adjust at least one quote based on the discrepancies.

2. The system of claim 1, wherein the project parameters comprise a building plan, a scope of work, and a materials specification.

3. The system of claim 1, wherein executing the instructions further causes the processing system to display an advertisement to the builder when the builder is entering or reviewing the project parameters, wherein the advertisement includes content that substantially relates to the project parameters.

4. The system of claim 3, wherein the advertisement is provided by a manufacturer, supplier, or contractor to the builder.

5. The system of claim 1, wherein executing the instructions further causes the processing system to request an updated bid from a preferred contractor based on the adjusted quotes.

6. The system of claim 1, wherein executing the instructions further causes the processing system to maintain a historical database comprising a plurality of contracts having project parameters and the corresponding bids received from contractors for each of the contracts.

7. The system of claim 6, wherein at least one quote is adjusted based on a comparison with substantially similar quotes received in bids maintained in the historical database.

8. The system of claim 6, wherein executing the instructions further causes the processing system to permit a builder to access at least a portion of the historical database when entering the project parameters.

9. The system of claim 1, wherein executing the instructions further causes the processing system to provide the received bids having the adjusted quotes to the builder and permit the builder to select a bid.

10. The system of claim 1, wherein the builder selecting the bid forms a contract between the builder and the contractor providing the selected bid.

11. The system of claim 10, wherein the memory further stores a plurality of form contracts and further wherein the system provides the contract to the contracting builder and contractor.

12. The system of claim 1, wherein executing the instructions further causes the processing system to receive one or more payment requests from the selected contractor during performance of the contract and to provide said payment requests to the builder, wherein the builder can approve or deny the payment requests.

13. The system of claim 12, wherein approval of the payment request by the builder may be provided to a financial institution to confirm that the builder has actually made payment to the contractor.

14. A system for managing contracts, the system comprising:
a communication system configured to operate on a communications medium and to receive bids from a plurality of contractors, each bid including a quote corresponding to a project parameter;
a memory for storing the bids and the project parameters; and
a processing system configured to map each quote in the bids to the corresponding project parameter and to compare the project parameters included in the quotes so as to identify discrepancies between the quotes, the processing system being further configured to adjust the quotes such that the project parameters are substantially similar between the received bids.

15. The system of claim 14, wherein the communications medium is the internet.

16. The system of claim 14, wherein the processing system is further configured to receive the bids from the plurality of contractors via one or more web pages.

17. The system of claim 14, wherein the processing system is further configured to permit at least one builder to enter the project parameters.

18. The system of claim 17, wherein the processing system is further configured to display an advertisement to the builder when the builder is entering or reviewing the project parameters, wherein the advertisement includes content that substantially relates to the project parameters being entered.

19. The system of claim 14, wherein the processing system is a web server operating on the internet.

20. A method for managing contract bids, the method comprising:
receiving bids from a plurality of contractors, each bid including a quote corresponding to a project parameter;
mapping, by a processing system, each quote in the received bids to the corresponding project parameter;
identifying, by the processing system, a discrepancy between a project parameter submitted by a first contractor and a project parameter submitted by a second contractor; and
adjusting at least one quote associated with the first contractor based on matching the project parameter submitted by the first contractor to the project parameter submitted by the second contractor.

21. The method of claim 20, further comprising the step of displaying an advertisement to a builder entering or reviewing the project parameters, wherein the advertisement includes content that substantially relates to the project parameters being entered.

22. The method of claim 20, wherein the bids are received from the plurality of contractors via the internet.

23. The method of claim 20, further comprising the step of requesting an updated bid from at least one of the contractors based on the adjusted quotes.

24. The method of claim 20, further comprising the step of maintaining a historical database comprising a plurality of previously awarded contracts having project parameters and the corresponding bids received from contractors for each of the contracts.
